(19) United States
(12) Patent Application Publication
(10) Pub. No.: US 2003/0009744 A1
(43) Pub. Date: Jan. 9, 2003

(54) Source code line counting system and method

(75) Inventors: Jeanne L. Doyle, Troy, MI (US); Lance W. Evert JR., Sterling Heights, MI (US); Jeffrey J. Kloster, St. Clair Shores, MI (US)

Correspondence Address: David G. Wille, Esq., Baker Botts L.L.P., Suite 600, 2001 Ross Avenue, Dallas, TX, 75201-2980, US

(73) Assignee: Electronic Data Systems Corporation

(21) Appl. No.: 09/899,868

(22) Filed: Jul. 5, 2001

(51) Int. Cl. G06F 9/44

(52) U.S. Cl. 717/120

(57) ABSTRACT

One aspect of the invention is a method of counting lines of source code. One of a plurality of sets of configuration data is selected wherein each set of the plurality of sets of configuration data is associated with at least one computer language. Collectively the plurality of sets of configuration data are associated with a plurality of computer languages and the selected set of configuration data comprises the keywords for a first computer language. A first file is parsed wherein the first file contains computer source code written in the first computer language to create a first token stream in response to the selected set of configuration data. A first list of statements is created in response to the first token stream and a count value is generated in response to the first list of statements.

### TECHNICAL FIELD OF THE INVENTION

This invention relates to computer software and more particularly to a method and system for counting lines of source code.

### BACKGROUND OF THE INVENTION

For various reasons, owners and licensees of computer software source code may desire to know the number of source lines of code in a particular computer software application, library, module, etc. While there are some computer programs available to automatically calculate the number of source lines of code in a particular source code file, these applications are normally only capable of counting source lines of code for a single computer language. While there is an IEEE standard directed to counting source lines of code, the standard has flexibility and various existing programs for counting source lines of code often arrive at different answers for the same source code file.

Because existing programs are typically constrained to a single programming language, a user of software who has applications written in many different programming languages often incurs a large expense in obtaining software to count source lines of code for each different programming language needed. In some cases, no program is available for particular languages to count source lines of code for that language.

### SUMMARY OF THE INVENTION

One aspect of the invention is a method of counting lines of source code. One of a plurality of sets of configuration data is selected wherein each set of the plurality of sets of configuration data is associated with at least one computer language. Collectively the plurality of sets of configuration data are associated with a plurality of computer languages and the selected set of configuration data comprises the keywords for a first computer language. A first file is parsed wherein the first file contains computer source code written in the first computer language to create a first token stream in response to the selected set of configuration data. A first list of statements is created in response to the first token stream and a count value is generated in response to the first list of statements.

The invention has several important technical advantages. Various embodiments of the invention may have none, some, or all of these advantages. The invention may allow consistent statistical measures to be produced for a variety of languages related to the number of lines of source code in particular software applications, libraries, modules, etc. The invention may be easily adapted to add new languages or make changes when new versions of existing languages are created. The invention can also allow comparison between a new version of a piece of software and a former version in order to produce one or more statistical measures of how the new version has changed from the former version. The ability to see how a version of software has changed may allow an analysis of the productivity of those who created the new version of the software.

### BRIEF DESCRIPTION OF THE DRAWINGS

For a more complete understanding of the present invention and the advantages thereof, reference is now made to the following descriptions taken in connection with the accompanying drawings in which:

FIG. 1 illustrates an example of a general purpose computer that may be used with the present invention;

FIG. 2 illustrates a block diagram of an example embodiment of a source code line counting system constructed in accordance with the invention.

FIG. 3 illustrates an example of the operation of a parser that may be used in the system of FIG. 2;

FIG. 4 illustrates one example of how a characterizer may operate in connection with the system of FIG. 2;

FIG. 5 illustrates an example of the operation of a statement builder used with the system of FIG. 2; and

FIG. 6 illustrates an example of the operation of a counter for use with the system of FIG. 2.

### DETAILED DESCRIPTION OF THE INVENTION

The invention and its advantages are best understood by referring to FIGS. 1-6 of the drawings, like numerals being used for like and corresponding parts of the various drawings.

FIG. 1 illustrates a general purpose computer 10 that may be used to execute all or portions of source code line counting system 30. General purpose computer 10 may be adapted to execute any of the well known MS-DOS, OS-2, UNIX, MAC-OS, Linux and Windows operating systems or other operating systems. General purpose computer 10 comprises processor 12, random access memory (RAM) 14, read-only memory (ROM) 16, mouse 18, keyboard 20 and input/output devices, such as printer 24, disk drives 22, display 26 and communications link 28. The present invention includes computer software that may be stored in RAM 14, ROM 16 or disk drives 22 and may be executed by processor 12. Communications link 28 may be connected to a telephone line, an antenna, a gateway, the Internet or any other type of communication link. Disk drives 22 may include a variety of types of storage media such as, for example, floppy disk drives, hard disk drives, CD ROM drives, or magnetic tape drives. Although this embodiment employs a plurality of disk drives 22, a single disk drive 22 could be used without departing from the scope of the invention. FIG. 1 only provides one example of a computer that may be used with the invention. The invention could be used on computers other than general purpose computers as well as on general purpose computers without conventional operating systems.

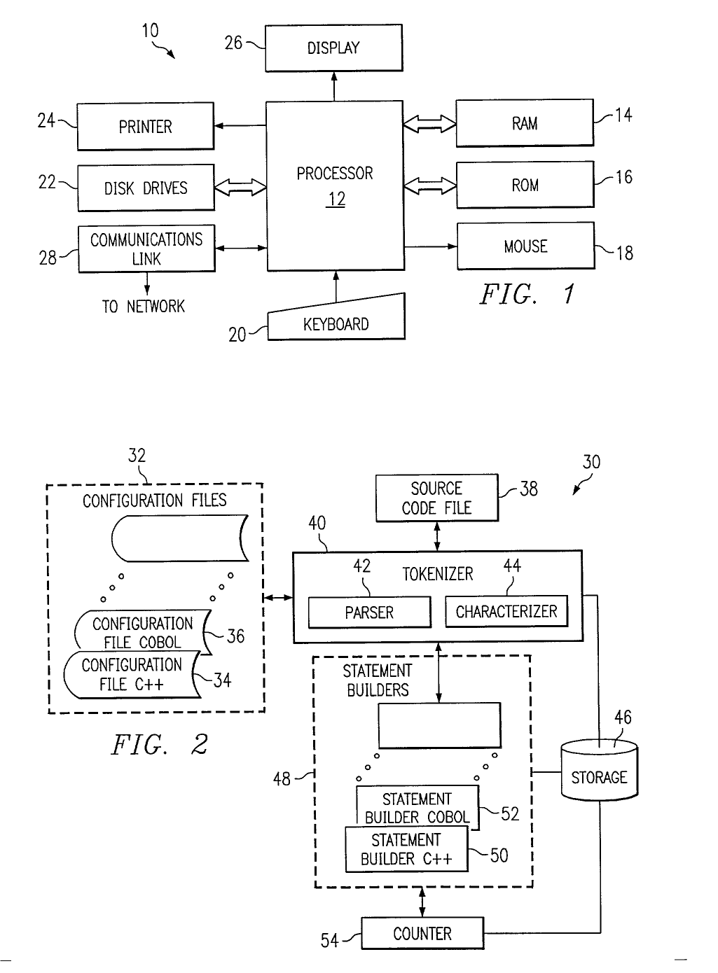

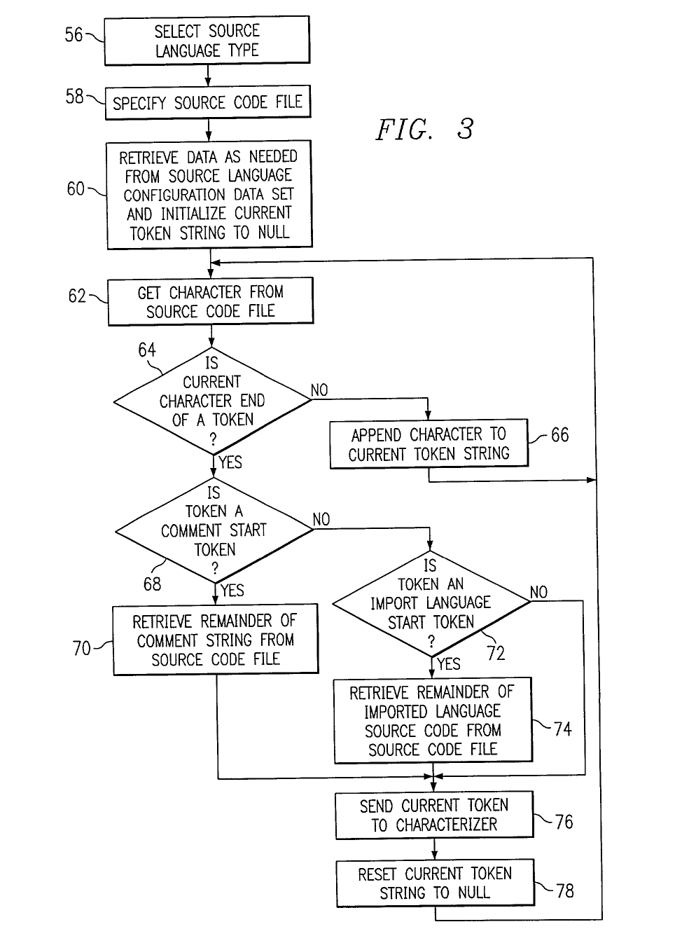

FIG. 2 illustrates an example of a source code line counting system 30 constructed in accordance with the invention. Source code line counting system 30 operates on one or more source code files 38 to produce statistical measures related to the number of lines of source code in source code file 38. Source code line counting system 30 may be used to compute these statistical measures for computer source code written in any of a plurality of programming languages.

A plurality of configuration files 32 are provided to supply information concerning particular programming languages or groups of programming languages for system 30. In the illustrated example, configuration files for the language C++ and Cobol are provided along with a plurality of additional configuration files. Configuration files may be provided for any number of languages such as C, C++, Cobol, Fortran, Basic, HTML, Java, JavaScript, JavaScript embedded in HTML, PL/1, SQL, SQL embedded in C, SQL embedded in COBOL, Visual Basic, and Unix Scripts. These are only examples of the programming languages for which configuration files may be provided. A configuration file for any type of programming language could be provided. Depending upon the design of system 30, a different configuration file could be provided for different software vendor's versions of various language or a common configuration file could be used with information regarding each of these versions. Configuration files 32 will typically contain the keywords for a particular language and may contain other information, such as the nature of each keyword. Configuration data could be stored in memory, a database, or some configuration data could be combined in a single file without departing from the scope of the invention. The invention may use a configuration data set of any type.

System 30 further comprises tokenizer 40. Tokenizer 40 is used to parse a file containing computer source code to create a token stream using one of the configuration files 32. Tokenizer 40 may associate a token type with each token in the token stream. A token is broadly defined as a string of one or more characters. Normally, a token will be a string of characters having some significance or meaning for a particular computer language. Parser 42 is used to parse source code file 38 to identify tokens. Characterizer 44 may then be used to characterize a particular token using information from the appropriate configuration file 32. As the token stream is generated (including the optional generation of token types), the token stream may be stored in storage 46. Storage 46 may comprise any type of computer readable storage medium.

The token stream is used by one of the statement builders 48 to create a statement list. The statement list created by one of the statement builders 48 may then be used by counter 54 to compute one or more statistical measures related to the number of source lines of code in source code file 38. As with the token stream, the statement list may be stored in storage 46, but could also be stored elsewhere. In this embodiment, a plurality of statement builders are provided. For example, a statement builder 50 for the language C++ is provided while a statement builder 52 for the language Cobol is also provided. A statement builder may be provided for each programming language or a single statement builder may be used for a plurality of programming languages. Some programming languages are closely related and a single statement builder may be used for a group of languages. In addition, a single statement builder may be used for different versions of the same language produced by different software vendors. However, a different statement builder could be used for each language and each version of the same language without departing from the scope of the invention. In addition, a single statement builder could be used for all languages without departing from the scope of the invention.

In this embodiment, a plurality of statement builders is used to desirably simplify the design of system 30. Because each statement builder 48 may be tailored to a particular language or group of languages, the logic used to decode the token stream is simpler than it would be if a single statement builder 48 was used to handle many disparate languages. The operation of system 30 will be further described in connection with FIGS. 3-6 below. Although a particular structure has been illustrated in FIG. 2 for system 30, the functions performed by the various modules of system 30 could be performed by software organized in a different manner without departing from the scope of the invention. For example, the functions of parser 42 and characterizer 44 could be combined into a single software module. Besides reorganizing the architecture of system 30, portions of system 30 could be executed on a single computer or a plurality of computers without departing from the scope of the invention. In addition, data and software used by system 30 may be stored on a single computer or a plurality of computers without departing from the scope of the invention.

FIG. 3 illustrates an example method of operation for parser 42. Other methods of operation could be used without departing from the scope of the invention. In step 56, the type of source code that the computer software stored in source code file 38 was written in is selected. In this embodiment, the source language type may be selected in response to input from a user of system 30. Alternatively, system 30 could use computer software to analyze source code file 38 to identify the type of source code used for the software contained in source code file 38.

In step 58, the source code file to be analyzed with respect to the number of lines of source code is specified. In step 60, data is retrieved as needed from a source language configuration data set and the current token string is initialized to a null string. As noted above, this embodiment employs a plurality of configuration files 32 to maintain the configuration data. Alternatively, the configuration data for a particular language could be maintained in any other type of data set such as a section of a database or a data structure maintained in memory. Any form of maintaining a set of configuration data associated with one or more computer languages or one or more versions of a computer language could be used without departing from the scope of the invention.

In step 62, the next character is read from the source code file. In step 64, it is determined whether the current character is the end of a token. If not, then the character is appended to the current token string in step 66 and the process continues in step 62. If the current character is the end of a token, then it is determined in step 68 whether the token is the beginning of a comment in the source code. If so, then the remainder of the comment string is retrieved from the source code file in step 70 and the remainder is concatenated to the current token string. If in step 68 the token was not the beginning of a comment, then it is determined in step 62 whether the token signals the start of the importation of a different computer language. Some computer languages allow the insertion of source code written for a different programming language within the source code for a native language. In this embodiment, such source code is not considered part of the lines of source code for counting purposes. However, such lines of source code could be counted without departing from the scope of the invention and the invention could count such lines using an appropriate one of the configuration files 32 associated with the language of the different programming language that has been imported into the source code file being parsed. If in step 72 the token does indicate the importation of source code for a different programming language, then the remainder of the imported language is retrieved from the source code file in step 74. In step 76, the current token string is sent to the characterizer for characterization. In step 78, the current token string is reset to null and the process continues in step 62. If the token is the last token in the file, then the process would terminate after step 78 (not explicitly shown).

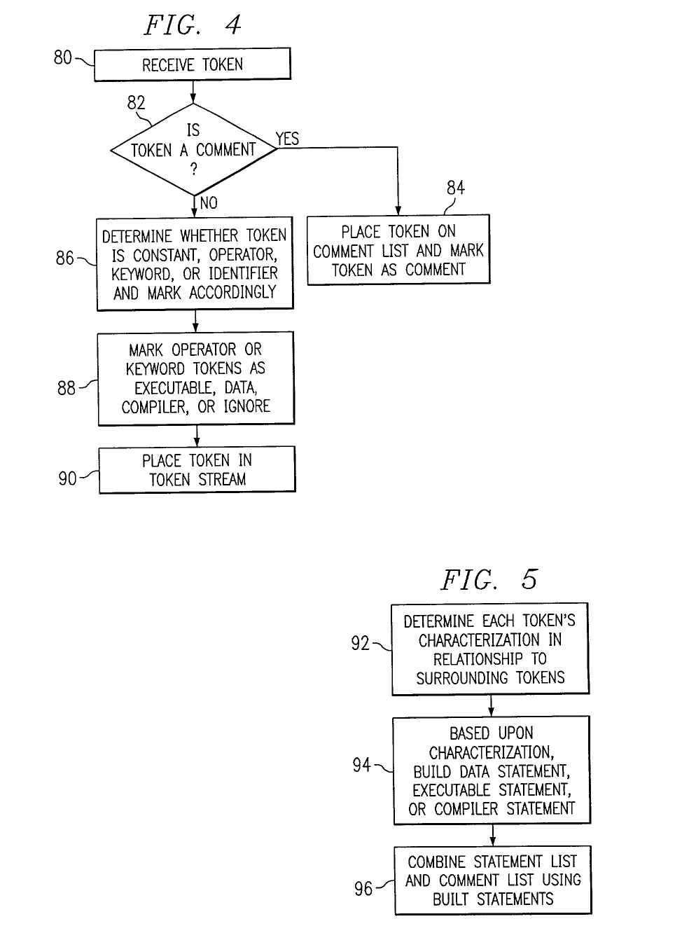

FIG. 4 illustrates an example method of operation for characterizer 40. This embodiment of characterizer 40 creates a list of comments independent from the token stream created by tokenizer 40. In other embodiments, comments could simply be treated as tokens and be inserted into the token stream. In addition, without departing from the scope of the invention, characterizer 44 could generate a plurality of token streams.

In this embodiment, a token is received in step 80. In step 82 is determined whether the token is a comment. If so, then the token is marked as a comment and placed on the comment list in step 84. The comment list may be stored in storage 46 or in other storage.

If the token was not a comment, then it is determined in step 86 whether the token is a constant, an operator, a keyword, or an identifier. The token is marked accordingly and a token-type value is associated with the token. The possible token-type values in this embodiment are constant, operator, keyword and identifier. However, some of these token types may be deleted or other token types added without departing from the scope of the invention. Any token types deemed useful could be used. In addition, the token type value can be any type of data operable to indicate the token type. Thus, for example, a string identifying the token type could be used, an integer could be used, or a binary value could be used to signify the token type.

In step 88, operator or keyword tokens may also have a subtype assigned to them. In this embodiment, allowable subtypes are executable, data, compiler, or ignore. Other subtypes may be included or some of these subtypes excluded as options without departing from the scope of the invention. In this embodiment, an executable operator or keyword is one that fits the executable definition of IEEE standard 1045. However, any definition of executable operators or keywords may be used without departing from the scope of the invention. An example of an executable operator is an arithmetic operator. A data operator or keyword may be any type of operator or keyword that defines a data storage requirement. For example, the data type “integer” is a data keyword. A compiler operator or keyword is an operator or keyword that is used to direct the compiler for the computer language to take a specific action. The ignore subtype is used for an operator or keyword that is used in conjunction with other tokens to define a particular function of operation. For example, various keywords in Cobol have secondary keywords associated with them, and the secondary keywords serve as options to further define the operation defined by the keyword. Such secondary keywords may be ignored in computing an accurate statistical measure of the number of source lines of code for a source code file.

In step 90, the token is placed in the token stream along with the token type value or token subtype value associated with the token. Although this embodiment uses token types and subtypes, a plurality of token types could be used without departing from the scope of the invention. In addition, the subtypes and types could be combined to create a plurality of types. For example, rather than having an executable and compiler subtype for the type keyword, one could simply define a token type of executable keyword and another type of compiler keyword without departing from the scope of the invention.

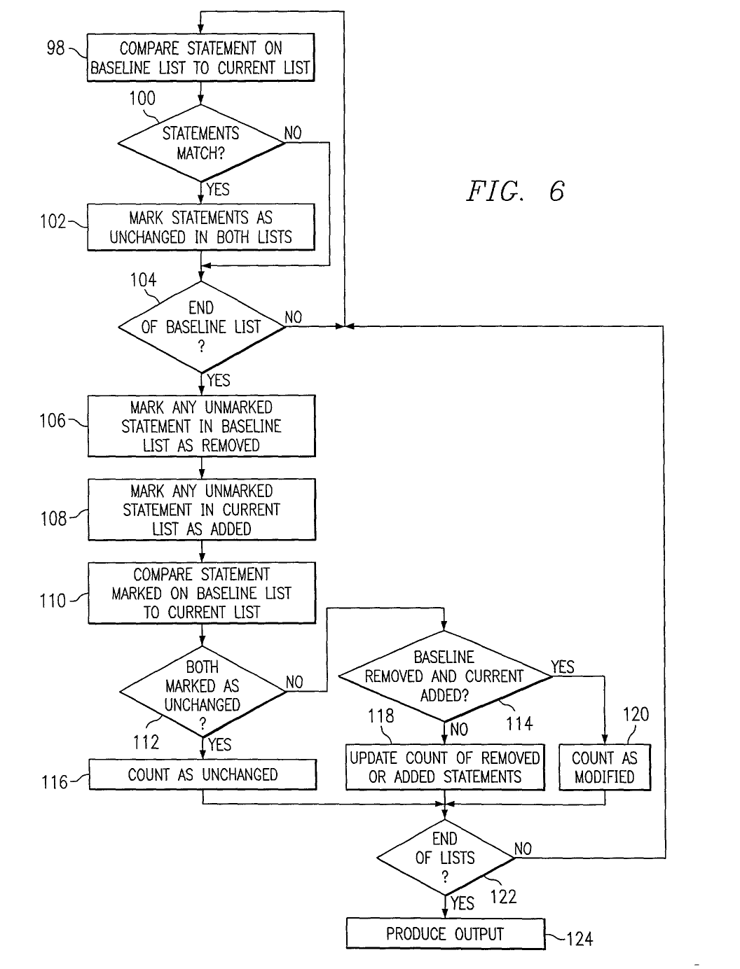

FIG. 5 illustrates an example method of operation for a statement builder 48 constructed in accordance with the teachings of the invention. Statement builder 48 is used to create a list of statements that may be counted for purposes of computing statistical measures related to the number of lines of source code for a particular language. The definition of what a statement is may vary with a particular language and may vary with the design of particular embodiments of the invention. In this embodiment, the invention defines statements in terms of discrete operations being performed. For example, the C language statement “int I=0” which consists of the tokens int, I, =, and 0, will be treated by a statement builder 48 as two statements. The first statement is a data statement −“int I” which is a data definition for the variable I. The second statement, which is “I=0” is an executable statement which assigns the value 0 to the variable I.

In step 92, each token is characterized in relation to its surrounding tokens. Then, in step 94, based upon the characterization, a statement is built comprising one or more tokens. In this embodiment, the statement can be a data statement, an executable statement or a compiler statement. A data statement comprises a statement that reserves storage space for data. An executable statement is a statement that will be executed when the program is run. A compiler statement is a statement that is an instruction to the compiler but does not comprise actual source code to be compiled. Other types of statements could be used or some of these types not used without departing from the scope of the invention. Depending upon the desires of the user of system 30, statement builders 48 could be designed to build and categorize statements of any type desired. In this embodiment, the type of statement is identified by a statement-type data value associated with the statement built by statement builder 48. In step 96, each statement that was built in step 94 is placed on the statement list. The statement list may be combined with the comment list that was generated by tokenizer 40. If desired, the comment list can be kept separate without departing from the scope of the invention. The combined statement list may then be counted using counter 54 to compute various statistical measures relating to the number of lines of source code in the source code file 38 being analyzed.

In this embodiment, the same statistical measures can be produced for different computer languages. Thus, in this embodiment the token type and data statement types used by tokenizer 40 and statement builders 48, may be chosen such that they do not vary based upon the language that the computer source code and the source code file was written in. Alternatively, in other embodiments, the token types and statement types may vary based upon the computer language of the source code being analyzed.

FIG. 6 illustrates an example method of operation of counter 54 constructed in accordance with the invention. In addition to the embodiment illustrated in FIG. 6, counter 54 may simply count the total of actual number of lines in source code file 38. This count may include or exclude comments and/or comments may be counted separately. This physical count of source lines of code may or may not be significant because in various languages the same number of logical lines of code may be placed on more or less physical lines of code. Accordingly, counter 54 may generate statistical measures based upon logical lines of code and physical lines of code in source code file 38. While this embodiment of counter 54, as will be seen below, allows the computation of statistical measures based upon the way a software application has changed since it was last analyzed by system 30, this functionality could be omitted without departing from the scope of the invention. If this functionality were omitted, then the number of statements generated by statement builder 48 could be counted to arrive at a total logical value for the number of lines of source code in source code file 38. In addition, the number of statements of a particular type could be computed and each measure reported separately and in the aggregate. Thus, for example, in the illustrated embodiment a total number of data statements, executable statements and compiler statements could be computed along with the total number of overall statements.

Turning to FIG. 6, this embodiment of counter 54 allows the user of system 30 to compute statistics based upon the way a software application has changed from its prior version. To use this optional feature of the invention, the statement list created by the appropriate statement builder 48 for the baseline version of a piece of source code is stored for future use. Alternatively, the statement list for the baseline file may be regenerated using the baseline source code at the time that the statement list is generated for the new version. When a new version of the software application is created, a statement list may be generated for the new version using system 30. Counter 54 may then compare the baseline list for the original version of the application to a current list for a new version of the application in order to compute various statistical measures related to the way the application has changed. Such statistical measures may be useful in measuring the productivity of persons who worked on the improved version of the software. Such statistical measures may also be useful in determining the significance of the changes made in the new version of the software.

In step 98, statements on the baseline list for the original version of the application are compared to a current list representing a later version of the application. Of course, the baseline list need not represent the very original version of the software application. Any two versions of the software may be compared using system 30 without departing from the scope of the invention. Those of skill in the art will understand that the comparison of the two lists is done with intelligent parsing so that additions and deletions may be identified and statements that have been modified may be identified.

In step 100, it is determined whether the statements from each list match. If so, then in step 102, each statement in the baseline list and the current list is marked as unchanged. In step 104, it is determined whether the end of the baseline list has been reached. If not, further comparison is done in step 98. If the end of the list has been reached, then in step 106 any unmarked statement in the baseline list is marked as removed. A statement is so marked because the failure to mark the statement as unchanged in step 102 indicates that no similar statement was found in the current list, indicating that the statement was likely deleted. In step 108, any unmarked statement in the current list is marked as added. The fact that a statement in the current list has not been previously marked when step 108 is reached indicates that the statement was not found in the baseline list and was likely added as a new statement. In step 110, statements marked on the baseline list are compared to corresponding statements on the current list. If both statements are marked in step 112, it is determined whether both statements are marked as unchanged. If so, then the counter for the number of statements unchanged is incremented in step 116.

In step 114, it is determined whether a baseline statement is marked as removed and a corresponding statement on the current list is marked as added. If so, then this indicates that while the statements did not match, there was likely a modification of the statement as opposed to a removal or addition. Thus, the modified counter is incremented by one in step 120. In step 118, the count of removed statements and/or added statements is incremented as appropriate and in step 122 it is determined whether the end of the list has been reached. If not, then the process returns to step 98. If so, then output is produced in step 124.

Although not explicitly shown, this embodiment may produce a count of the number of data statements, executable statements, and compiler statements in each of the baseline list and the current list. This embodiment may also produce a total of all statements in each list. This embodiment may also produce a list of the total number of comments in each of the baseline list and current list.

With respect to the statistical measures comparing a baseline version of an application to a later version of an application, this embodiment of the invention may produce a count of the number of statements that are unchanged, the number of statements that were modified, the number of statements that were removed, and the number of statements that were added. Depending upon the algorithm employed, the statistical measures may approximate or exactly define these values. Some of these values may be omitted or other values computed without departing from the scope of the invention.

The invention advantageously allows statistical measures to be computed related to the number of source lines of code of computer software for any one of a plurality of computer languages. Computer system 30 can be enabled to count lines of source code and compute the statistical measures for new computer languages and new versions of existing computer languages by adding or altering one of the configuration files 32 and adding a statement builder 48 or adjusting an existing statement builder 48. Thus, the invention is adaptable to a plurality of computer languages.

Although the present invention has been described in detail, it should be understood that various changes, substitutions, and alterations can be made hereto without departing from the spirit and scope of the invention as defined by the appended claims.

To aid the patent office and any readers of any patents issued on this application in interpreting the claims appended hereto, Applicants wish to note that they do not intend any of the appended claims to invoke paragraph 6 of 35 U.S.C. §112 as it exists on the date of filing hereof unless the words “means for” or “step for” are used in the particular claim.

What is claimed is:

1. A source code line counting system, comprising:
a computer readable storage medium; and
a software counting tool stored on the computer readable storage medium and operable to
parse a first file containing computer source code to create a token stream in response to one of a plurality of sets of configuration data,
wherein the computer source code in the file was written in one of a plurality of computer languages that may be processed by the software counting tool,
wherein each set of configuration data comprises keywords for one or more of the plurality of computer languages,
create a list of statements in response to the token stream, and
generate a count value in response to the list of statements.

2. The system of claim 1, wherein the plurality of sets of configuration data includes a different set for each of the following computer programming languages: C++ and Cobol.

3. The system of claim 1, wherein the plurality of sets of configuration data includes a different set for at least two of the following computer programming languages: C, C++, Java, Fortran, Cobol, and Basic.

4. The system of claim 1, wherein each token in the token stream comprises a string of one or more characters and wherein each token in the token stream is associated with a token type value.

5. The system of claim 4, wherein the token type value comprises a data value indicating that the token is of a type selected from the group comprising: an operator, a comment, a constant, a keyword, and an identifier.

6. The system of claim 4, wherein the possible token type values that can be chosen do not vary based upon the language that the computer source code in the first file was written in.

7. The system of claim 1, wherein portions of the token stream are ignored in generating the statement list because such portions are associated with a portion of the source code in the first file that is written in a language different from the one of the plurality of computer languages.

8. The system of claim 1, wherein each statement in the list of statements is further associated with a statement type value.

9. The system of claim 8, wherein the possible statement type values that can be chosen do not vary based upon the language that the computer source code in the first file was written in.

10. The system of claim 8, wherein the statement type value comprises a data value indicating that the statement is of a type selected from the group comprising: data, executable, and compiler.

11. The system of claim 1, wherein the statement list is created by examining the relationship of a token in the token stream to other tokens preceding or following the token in question.

12. The system of claim 1, wherein the software counting tool is further operable to:
parse a second file containing computer source code to create a second token stream in response to the one of the plurality of sets of configuration data,
wherein the second file comprises a different version of the source code contained in the first file,
create a second list of statements in response to the second token stream, and
compare the first list of statements to the second list of statements to generate at least one count responsive to differences between the first list of statements and the second list of statements.

13. A method of counting lines of source code, comprising:
selecting one of a plurality of sets of configuration data,
wherein each set of the plurality of sets of configuration data is associated with at least one computer language,
wherein, collectively, the plurality of sets of configuration data are associated with a plurality of computer languages,
wherein the selected set of configuration data comprises the keywords for a first computer language,
parsing a first file containing computer source code written in the first computer language to create a first token stream in response to the selected set of configuration data,
creating a first list of statements in response to the first token stream, and
generating a count value in response to the first list of statements.

14. The method of claim 13, wherein the plurality of sets of configuration data includes a different set for each of the following computer programming languages: C++ and Cobol.

15. The method of claim 13, wherein each token in the token stream comprises a string of one or more characters and wherein each token in the token stream is associated with a token type value.

16. The method of claim 15, wherein the token type value comprises a data value indicating that the token is of a type selected from the group comprising: an operator, a comment, a constant, a keyword, and an identifier.

17. The method of claim 15, wherein the possible token type values that can be chosen do not vary based upon the language that the computer source code in the first file was written in.

18. The method of claim 15, wherein the plurality of sets of configuration data includes a different set for each of at least five different programming languages.

19. The method of claim 13, wherein each statement in the list of statements is further associated with a statement type value.

20. The method of claim 19, wherein the possible statement type values that can be chosen do not vary based upon the language that the computer source code in the first file was written in.

21. The method of claim 17, wherein each statement in the list of statements is further associated with a statement type value and wherein the possible statement type values that can be chosen do not vary based upon the language that the computer source code in the first file was written in.

22. The method of claim 13, further comprising:
parsing a second file containing computer source code to create a second token stream in response to the one of the plurality of sets of configuration data,
wherein the second file comprises a different version of the source code contained in the first file,
creating a second list of statements in response to the second token stream, and
comparing the first list of statements to the second list of statements to generate at least one count responsive to differences between the first list of statements and the second list of statements.

23. A source code line counting system, comprising:
a computer readable storage medium; and
a software counting tool stored on the computer readable storage medium comprising:
a plurality of configuration files, each associated with one or more of a plurality of computer languages,
a tokenizer operable to parse a file containing computer source code written in a first computer language to create a token stream,
wherein the parser is operable to parse source code written in any of the plurality of computer languages,
wherein the parser creates the token stream in response to the configuration file associated with the first computer language;
a first statement builder operable to create a list of statements in response to the token stream, and
a counter operable to generate a count value in response to the list of statements.

24. The system of claim 23, further comprising:
a plurality of additional statement builders wherein each of the plurality of statement builders are associated with one or more computer languages and operable to generate a statement list in response to a token stream generated from a source code file written in the associated one or more computer languages.

25. The system of claim 23, wherein each token in the token stream comprises a string of one or more characters and wherein each token in the token stream is associated with a token type value.

26. The system of claim 25, wherein the possible token type values that can be chosen do not vary based upon the language that the computer source code in the first file was written in.

27. The system of claim 25, wherein each statement in the list of statements is further associated with a statement type value.

28. The system of claim 27, wherein the possible statement type values that can be chosen do not vary based upon the language that the computer source code in the first file was written in.

29. A method of measuring changes in source code comprising:
parsing a first file containing computer source code to create a first token stream,
creating a first list of statements in response to the first token stream,
parsing a second file containing computer source code to create a second token stream,
creating a second list of statements in response to the second token stream, and
comparing the first list of statements to the second list of statements to generate at least one count responsive to a comparison between the first list of statements and the second list of statements.

30. The method of claim 29, wherein the at least one count is equal or approximately equal to a total number of statements in the second list of statements that are modified versions of statements in the first list of statements.

31. The method of claim 29, wherein the at least one count is equal or approximately equal to a total number of statements on the second list of statements that did not appear on the first list of statements.

32. The method of claim 29, wherein the at least one count is equal or approximately equal to a total number of statements on the first list of statements that did not appear on the second list of statements.

33. The method of claim 29, wherein the at least one count is equal or approximately equal to a total number of statements on the first list of statements that also appear on the second list of statements.

34. The method of claim 29, wherein the second file comprises a modified version of the first file and wherein the comparing step generates data approximating or equal to each of the following:
a total number of statements in the second list of statements that are modified versions of statements in the first list of statements,
a total number of statements on the second list of statements that did not appear on the first list of statements,
a total number of statements on the first list of statements that did not appear on the second list of statements, and
a total number of statements on the first list of statements that also appear on the second list of statements.

35. A source code line counting system, comprising:
a computer readable storage medium; and
a software counting tool stored on the computer readable storage medium and operable to
parse a first file containing computer source code to create a first token stream,
create a first list of statements in response to the first token stream,
parse a second file containing computer source code to create a second token stream,
create a second list of statements in response to the second token stream, and
compare the first list of statements to the second list of statements to generate at least one count responsive to a comparison between the first list of statements and the second list of statements.

36. The system of claim 35, wherein the second file comprises a modified version of the first file and wherein the comparing step generates data approximating or equal to each of the following:
a total number of statements in the second list of statements that are modified versions of statements in the first list of statements,
a total number of statements on the second list of statements that did not appear on the first list of statements,
a total number of statements on the first list of statements that did not appear on the second list of statements, and
a total number of statements on the first list of statements that also appear on the second list of statements.

37. A source code line counting system, comprising:
a computer readable storage medium;
a plurality of sets of configuration data, each set associated with at least one computer language, the plurality collectively associated with different computer languages; and
a software counting tool stored on the computer readable storage medium and operable to
receive a source code file, and
compute a statistical measure related to the number of lines of source code in the source code file using the one of the plurality of sets of configuration data associated with the computer language that the source code in the source code file was written in.
